(19) United States
(12) Patent Application Publication
(10) Pub. No.: US 2017/0148438 A1
(43) Pub. Date: May 25, 2017

(54) INPUT/OUTPUT MODE CONTROL FOR AUDIO PROCESSING

(71) Applicant: CONEXANT SYSTEMS, INC., Irvine, CA (US)

(72) Inventors: Randall Deetz, Las Vegas, NV (US); Trausti Thormundsson, Irvine, CA (US); Stuart Whitfield Hutson, Austin, TX (US); Thorarinn Sveinsson, Irvine, TX (US); Yair Kerner, Kiryat Ono, IL (US)

(21) Appl. No.: 15/356,401

(22) Filed: Nov. 18, 2016

Related U.S. Application Data
(60) Provisional application No. 62/258,374, filed on Nov. 20, 2015.
(60) Provisional application No. 62/377,495, filed on Aug. 19, 2016.

(51) Int. Cl. G10L 15/22; H04L 29/06; H04M 7/00; G10L 15/18; G06F 3/16

(52) U.S. Cl. CPC G10L 15/22; G10L 15/1815; G06F 3/165; H04M 7/006; H04L 65/403; G10L 2015/223

(57) ABSTRACT

Systems and methods provide input and output mode control for audio processing on a user device. Audio processing may be configured by monitoring audio activity on a device having at least one microphone and a digital audio processing unit, collecting information from the monitoring of the activity, including an identification of at least one application utilizing audio processing, and determining a context for the audio processing, the context including at least one context resource having associated metadata. An audio configuration is determined based on the application and determined context, and an action is performed to control the audio processing mode. User controls providing addition mode control may be displayed automatically based on a current application and determined context.

### CROSS-REFERENCE TO RELATED APPLICATIONS

The present application claims priority to U.S. provisional patent application No. 62/258,374, filed Nov. 20, 2015, and U.S. provisional patent application No. 62/377,495, filed Aug. 19, 2016, each of which is fully incorporated by reference as if set forth herein in its entirety.

### BACKGROUND

Technical Field

The present disclosure generally relates to electronic processing of audio signals and, more particularly, to controlling input and output audio processing modes on an end user device such as a tablet, laptop, or mobile phone.

Related Art

Many electronic devices, such as tablets, laptops, and mobile phones, process audio signals on the input side (e.g., the audio signal being captured by one or more microphones) and the output side (e.g., the audio signal being played through one or more loudspeakers or headsets). Users typically control audio processing through user interfaces provided on the device. For example, a computer may include various drivers and control panels providing a graphical user interface (GUI) allowing the user to configure available audio processing controls.

One drawback with existing audio processing systems is that users may not understand the available configurations or how to control the audio processing for a particular environment and intended use, resulting in an audio processing configuration that does not provide optimal performance. For example, audio control settings optimized for a Voice over IP (“VoIP”) call may be different than settings for recording a video, watching media content, or talking on a phone at a crowded location. The optimal audio control settings may also change depending on a current hardware configuration that is in use, such as playback through internal speakers, headphones or an external audio system.

A user may also be inconvenienced or overwhelmed by the process of continually setting audio controls and may simply select a single mode for all uses that may or may not provide acceptable audio processing across all intended uses for the device. Often, a user may not even have an idea of how to get to the control panel on the device for controlling the audio mode and, even so, the effect that each control setting has on the audio processing may not be transparent to the user. In many cases, a user may simply avoid changing the audio settings and rely on the default settings for the system.

Thus, there is a need in the art for solutions to optimize audio processing on end user devices.

### SUMMARY

The present disclosure provides methods and systems that address a need in the art of for configuring and optimizing audio processing. Embodiments of the present disclosure include an analysis of media content and context information available from a user device that is then used to determine the source and context of the audio signal being processed and for which control and optimization of the audio processing configuration may be desired.

In one embodiment, audio processing may be configured by monitoring audio activity on a device having at least one microphone and a digital audio processing unit, collecting information from the monitoring of the activity, including an identification of at least one application utilizing audio processing and any associated audio media, and determining a context for the audio processing. In one embodiment, the context may include at least one context resource having associated metadata. An audio configuration is determined based on the application and determined context, and an action is performed to control the audio processing mode. User controls providing addition mode control may be displayed automatically based on a current application and determined context.

In another embodiment, a system includes an audio input/output system, including an audio driver and an audio codec, that interfaces with an audio input device, such as one or more microphones, and an audio output device, such as one or more loudspeakers. An audio processing module provides input and/or output audio processing between the audio input/output system and at least one application. In one embodiment, the audio processing module may include acoustic echo cancellation, target source separation, noise reduction and other audio processing modules. An audio processing control module monitors the audio systems and may automatically configure the audio processing.

In one embodiment, the audio processing control module includes an audio monitor, a context controller, and an audio configuration interface. The audio monitor tracks available audio input and output resources and active audio applications. The context controller utilizes available audio usage data, audio context data, context resources, and current audio processing configuration information, and sets a current audio processing configuration. The audio configuration interface provides the user with an interactive user interface for configuring the audio processing system.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 is a system block diagram of an audio processing system according to one or more embodiments.

FIG. 2 is a block diagram of illustrating an embodiment of the audio processing control in accordance with one or more embodiments.

FIG. 3 is a flow chart of a method for context aware control and configuration of audio processing performed by a device in accordance with one ore more embodiments.

FIG. 4 is a block diagram of an audio processing system in accordance with one or more embodiments.

FIG. 5 is a flow chart of a method for context aware control and configuration of audio output processing performed by a device in accordance with one or more embodiments.

The included drawings are for illustrative purposes and serve only to provide examples of possible systems and methods for the disclosed methods and system for providing input and output mode control and context aware audio processing. These drawings in no way limit any changes in form and detail that may be made to that which is disclosed by one skilled in the art without departing from the spirit and scope of this disclosure.

### DETAILED DESCRIPTION

The present disclosure provides methods and systems that address a need in the art of for configuring and optimizing audio processing. Embodiments of the present disclosure may be contrasted to pre-existing solutions for processing of audio signals that attempt to analyze the content of the signal that is being played back (e.g., try to determine if the source of the signal is music, speech, or a movie) and alter the playback processing based on the determination of content. These solutions are limited, however, in that they may be unable to distinguish between different contexts, such an interview that is being played back or an ongoing VoIP call.

Embodiments of the present disclosure include an analysis of media content and context information available from a user device that is then used to determine the source and context of the audio signal being processed and for which control and optimization of the audio processing configuration may be desired.

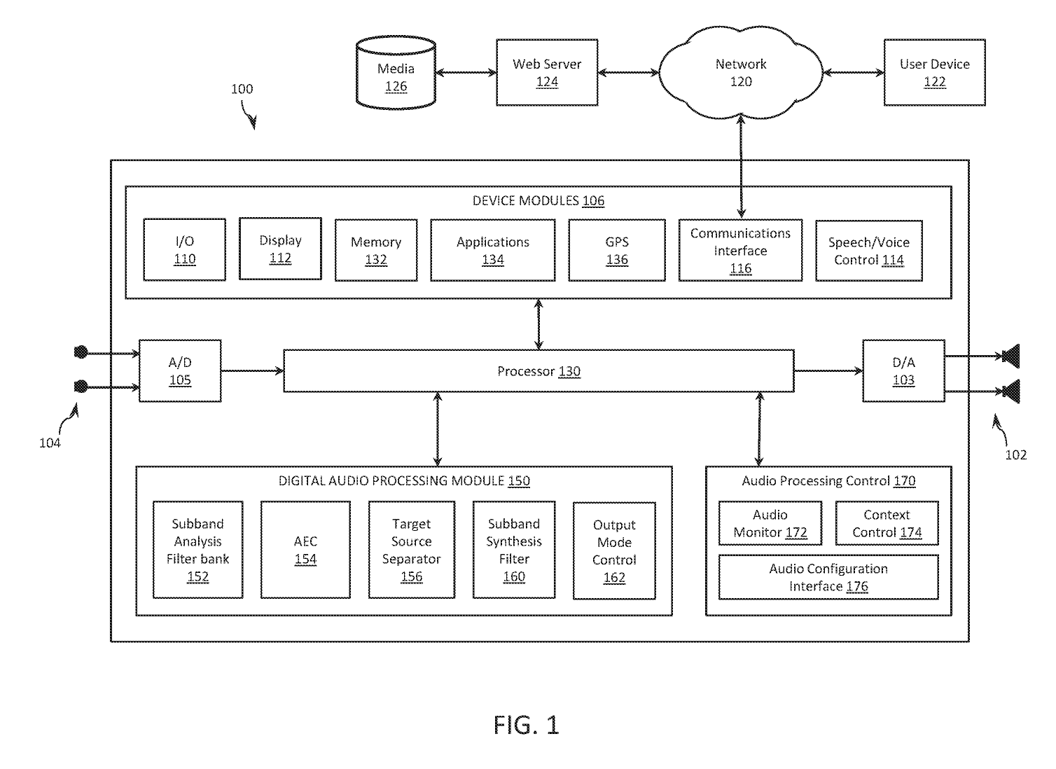

Referring to FIG. 1 an embodiment of an exemplary device 100 embodying an audio processing system is described. The device 100 may be implemented as a mobile device, such as smart phone or laptop computer, a television or display monitor, a desktop computer, an automobile, or other device or subsystem of a device that provides audio input and/or output processing. As shown the exemplary device 100 includes at least one audio endpoint device which may include a playback source, such as loudspeakers 102, and at least one audio sensor, such as microphones 104. Analog-to-digital converter 105 is configured to receive audio input from the audio sensor 104. The system may also include a digital-to-audio converter 103 which provides an analog signal to loudspeaker 102. In one embodiment, the ADC 105 and DAC 103 may be provided on a hardware codec that encodes analog signals received from the input sensor 104 into digital audio signals, decodes digital audio signals to analog, and amplifies the analog signals for driving the loudspeaker 102.

Device 100 includes a bus or other communication mechanism for communicating information data, signals, and information between various components of the device 100. Components include device modules 106, providing device operation and functionality. The device modules 106 may include an input/output (I/O) component 110 that processes a user action, such as selecting keys from a keypad/keyboard, or selecting one or more buttons or links. I/O component 110 may also include or interact with an output component, such as a display 112. An optional audio input/output component may also be included to allow use of voice controls for inputting information or controlling the device, such as speech/voice detector and control 114 which receives processed audio signals containing speech, analyzes the received signals, and determines an appropriate action in response thereto.

A communications interface 116 includes a transceiver for transmitting and receiving signals between the device 100 and other devices or networks, such as network 120. In various embodiments, the network 120 may include the internet, a cellular telephone network, and a local area network, providing connection to various network devices, such as a user device 122 or a web server 124 providing access to media 126. In one embodiment, the communications interface 116 includes a wireless communications transceiver for communicating over a wireless network, such as a mobile telephone network or wireless local area network. GPS components 136 are adapted to receive transmissions from global positions satellites for use in identifying a geospatial location of the device 100.

A processor 130, which can be a micro-controller, digital signal processor (DSP), or other processing component, interfaces with the device modules 106 and other components of device 100 to control and facilitate the operation thereof, including controlling communications through communications interface 116, displaying information on a computer screen (e.g., display 112), and receiving and processing input and output from I/O 110.

The device modules 106 may also include a memory 132 (e.g., RAM, a static storage component, disk drive, database, and/or network storage). The device 100 performs specific operations through processor 130 which executes one or more sequences of instructions contained in memory 132. Logic may be encoded in a computer readable medium, which may refer to any medium that participates in providing instructions to processor 130 for execution. Such a medium may take many forms, including but not limited to, non-volatile media, volatile media, and transmission media. In various implementations, non-volatile media includes optical or magnetic disks, volatile media includes dynamic memory, such as memory 132. Logic for various applications operating on the device 100 may be stored in the memory 132, or in a separate application program memory 134. It will be appreciated that the various components of device 100 may reside in a single device or multiple devices, which may be coupled by a communications link, or be implemented as a combination of hardware and software components.

The device 100 further includes a digital audio processing module 150 which processes audio signals received from the microphones 104 or from other signal sources (e.g., a remote user device, media file) provided to the digital audio processing module 150 by the device 100. In one embodiment, the digital audio processing module 150 includes modules for providing subband noise cancellation, echo cancellation, target source identification, and output mode processing. It will be appreciated by those skilled in the art that other known audio processing techniques may also be used. As illustrated, the digital audio processing module 150 includes a subband analysis filter bank 152, an acoustic echo cancellation module 154, a target source detection module 156, a subband synthesis filter 160 and an output mode control module 162.

In one embodiment, the digital audio processing module 150 is implemented as a dedicated digital signal processor DSP. In an alternative embodiment, the digital audio processing module 150 comprises program memory storing program logic associated with each of the components 152 to 160, for instructing the processor 130 to execute the corresponding audio processing algorithms.

In one embodiment, the subband analysis filter bank 152 performs sub-band domain complex-valued decomposition with a variable length sub-band buffering for a non-uniform filter length in each sub-band. The subband analysis filter bank 152 is configured to receive audio data including a target audio signal, and to perform sub-band domain decomposition of the audio data to generate a plurality of buffered outputs. In one implementation the subband analysis filter bank 152 is configured to perform decomposition of the audio data as an undersampled complex valued decomposition using variable length sub-band buffering.

Optional acoustic echo cancellation module 154 removes echo signals from the processed audio signal, such as signals played through loudspeakers 102 and received as interference by microphones 104. In alternative embodiments, the acoustic echo cancellation may be performed after target source identification, at each microphone, or through other configurations as known in the art.

The target source detector 156 identifies and processes audio for one or more desired target sources. For example, the microphones 104 may pick up sounds from a variety of sources in a crowded restaurant, and the target source of interest may be the user of the device who is providing voice commands to the device, or communicating by voice over the communications interface 116, such as through a telephone call or VoIP call. In alternate embodiments, a target source separator may be implemented as a beam former, independent component analyzer or through other target source identification technology as known in the art. In one embodiment, the audio may be speech or other sounds produced by a human voice and the target source identifier attempts to classify a dominant target source, such as by generating a target presence probability corresponding to the target signal. In an alternate embodiment, the device 100 may be implemented in a conference call setting having a plurality of target speakers to be identified.

In an exemplary embodiment, the target source detector is uses blind source separation based on constrained Independent Component Analysis (ICA). The method may perform a dynamic acoustic scene analysis that produces multiple features used to condition the ICA adaptation. The features include estimation of number of acoustic sources, direction of arrival estimation, and classification of sources into interference, speech sources, and various statistical measures. The ICA produces a “deep” spatial representation of the target sources and the noise sources, even in highly reverberant conditions, because reverberation is implicitly modeled in the filtering. In one embodiment, the enhanced signal can be a true stereo output, where spatial information in the desired signal/signals is preserved while removing unwanted signal from both channels.

In one embodiment, the subband synthesis filter 160 receives and processes the target source information and recombines the subbands to produce a time domain output which may be provided to other components of device 100 for further processing.

The output mode control module 162 provides output processing that may include optimizations for the output endpoint devices 102, optimizations depending on audio stream media type, such as movie, speech, music or game, and other output optimizations.

The audio processing system 100 further includes an audio processing control module 170, which may be implemented, for example, as program logic stored in memory 132 or 134, and executed by processor 130. In one embodiment, the audio processing control 170 includes an audio monitor 172 and a context controller 174 that are run as background applications on device 100, and an audio configuration interface 176.

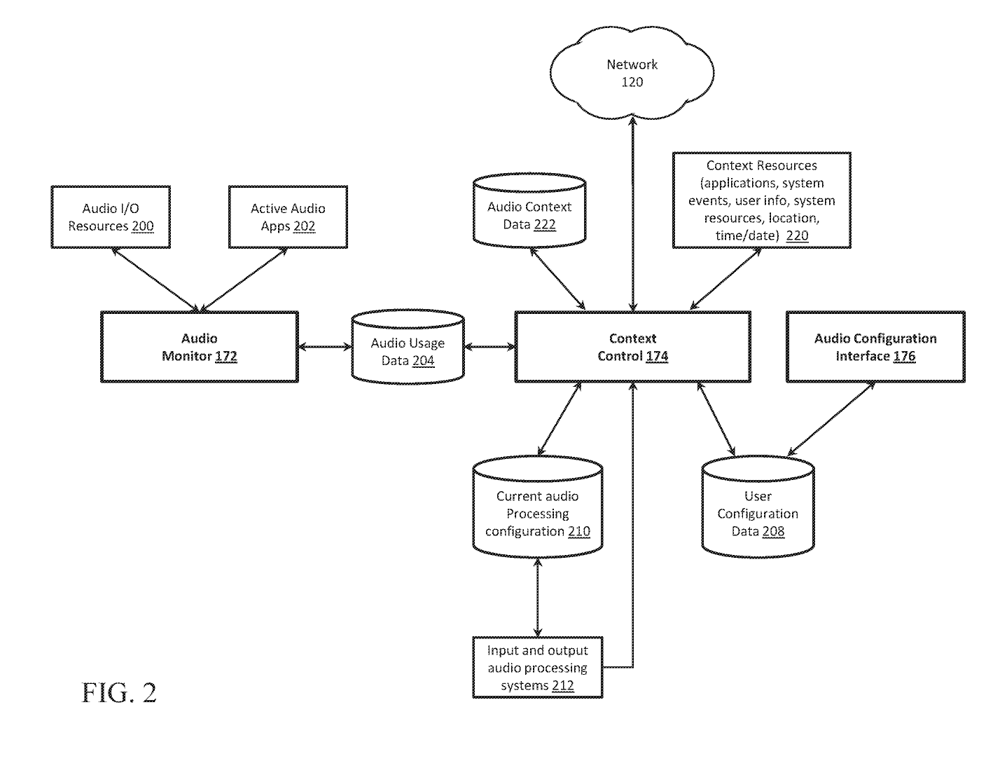

An embodiment of the operation of the audio processing controller 170 is illustrated in FIG. 2 and will be described with reference to the device 100 illustrated in FIG. 1. The audio monitor 172 may be implemented as program running in the background on the device 100 to monitor the use and processing of audio input and output resources 200 (such as microphones 104, loudspeakers 102, and communications interface 116), and system applications 202 that access the audio resources 202. The audio monitor 172 stores current audio usage data 204, including identification of the audio resources 200 utilized by associated audio applications 202. In one embodiment, the audio monitor 172 tracks in real time the applications that are using each available resource—for example, by monitoring active tabs or windows on a laptop operating system—and stores the real time information in the audio usage data storage 204.

The audio configuration interface 176 provides the user with an interactive user interface for configuring the audio processing system, which may include user selectable input processing modes such as beam forming, telephone conference, echo cancellation and voice-over-IP communications, and output processing options such as speech, music, movie, modes. The audio configuration interface 176 may also include a user-selectable option for activating and deactivating the audio monitor 172 and context controller 174. The user configuration information is stored in user configuration data storage 208.

The context controller 174 monitors the audio usage data 204 and sets the current audio processing configuration 210 for the input and output audio processing systems 212. In one embodiment, the context controller 174 tracks context resources 220 associated with the audio usage data 204, evaluates a current context for the use of the resource and stores associated audio context data 222, which may be used in real-time or stored for later use. The context resources 220 may include a location resources (e.g., GPS location, local network system, identification of location for event on calendar), appointment information (e.g., conference call), available resources (e.g., microphone array, external microphone/speakers), date and time (e.g., weekend, late night), media type, metadata and other sources identifying the expected usage of the device. The context controller 174 matches audio usage data 204 and user configuration data 208 to an associated context and stores context information in the audio context data storage 222.

In one embodiment, the context controller 174 tracks applications running on the device and sets the current audio processing configuration 210 in accordance with the user configuration data 208 and audio context data 222. For example, the audio processing system may be implemented in a mobile phone that may be used for a standard phone call, a speaker phone call, a video conference call and for recording videos. Each usage, and each context of usage, may have different configuration parameters.

The input and output audio processing systems 212 may provide additional feedback to the context controller 174 that may be stored in the audio context data 222 such as vocal parameters of a received target, noise parameters, and other information that may be used by the audio processor in a given context. The context controller 174 may also receive real-time context information from network 120 (such as the Internet) for a particular location or event (e.g., a concert), allowing the audio processing configuration to be adapted based on information received from other user devices.

It will be appreciated that the audio monitor 172, context controller 174 and audio configuration interface 176 may be combined or otherwise arranged as one or more software, firmware or hardware modules. In one embodiment, the context controller 174 tracks and configures audio activity in real time, for example, by detecting a received audio signal, identifying an associated application and determining the context configuration, without use of a separate audio monitor 172 or audio usage data 204.

In an exemplary embodiment, a mobile phone user may launch a video conference application, which requires the user to hold the phone at a distance that allows for viewing of the incoming video and capture of the user on the mobile phone camera. The appropriate audio settings for the video conference may depend on the context of use. If, for example, the context controller identifies the user location at an airport (e.g., by using GPS data), a setting that targets the user's voice while removing other noise sources could be used. If the user was at home with family on a video conference with a relative, it may be desirable to maintain other voices and received audio signals. Further, the audio playback settings could be optimized for speech.

The audio context data 222 may include any information that may cause a user to adjust audio settings or may be used by the audio processing system to process an audio signal. For example, context information may include identification of an ongoing VoIP call, a user joining a VoIP meeting, identification of who is participating in a VoIP meeting, location of a meeting (such as a conference room), identification of current speaker, and whether an application is currently playing a media file.

In one embodiment, the information collected by the context controller 174 is processed by a decision map that determines if the current audio processing parameters should be updated. Exemplary actions that may be taken by the context controller 174 can include:

1) Switching Input and Output Processing to Conference Mode.

In one exemplary embodiment, a laptop user joins a scheduled VoIP meeting he created that is set in a conference room. The audio monitor 172 and context controller 174 may identify when a user joins a VoIP meeting, for example, by adding an event handler on joining VoIP calls through appropriate a software development environment. A VoIP call may be associated with a calendar appointment through a calendar application (such as Microsoft Outlook), and the context controller 174 may identify the context of the VoIP call by searching calendar information for a matching meeting appointment. The meeting appointment may include the identity of other people attending the meeting, the meeting location (e.g., conference room), and other information useful for setting audio processing parameters. In operation, the user joins the VoIP call, which is identified by the audio monitor 172 and stored in the audio usage data 204. Context controller 174 identifies whether the user owns the call and if there is an associated appointment. If the appointment is located in a conference room, the context controller 174 changes the current audio processing configuration 210 to conference mode.

2) Deciding when to Display User Controls, and What Applications to Follow.

By monitoring which applications are running and which application is in focus (i.e, in the foreground), including what is visible in the application (such as a conversation window), the audio configuration interface 176 can be launched at appropriate times and locations for the user.

The information may be available to the audio monitor 172 by querying the operating system and storing the information in audio usage data 204. Context controller 174 may identify when an application is running, whether it is in the foreground, and whether a conversation window is open. For certain applications, an active conversation window may activate the launch of the audio configuration interface 176, providing configuration controls for the user. The context controller 174 tracks configuration changes for the current application and context and stores the information at audio content data 222, which may be used as a default configuration when the application is launched in the same or similar context.

3) Conference Virtualization.

Using context control information, the system may know how many people are on a VoIP call, and which user is speaking, This information may be used to virtually position each person so that when they speak the audio appears to come from their virtual position.

4) Configuring Playback Processing.

By storing audio context data 222 associated with context and user configuration data 208, the user preferences for each application can be used to identify the content associated with each application and use that information to configure playback processing for that application.

In one exemplary embodiment, the user opens a music playback application and launches a song. The context controller 174 accesses the audio context data 222 to determine that the music application is used for playing music and changes the current audio processing configuration to change the playback processing to a mode appropriate for music. In various embodiments, the audio content data 222 for an application may be a default configuration for an application, a user selected configuration, or a context based configuration. If the user closes the music application and opens a voice chat application, the context controller 174 will search for a matching configuration. In one embodiment, if the context controller cannot determine that a particular application is, for example, a voice chat application, the context controller 174 can launch the audio configuration interface 176 to ask the user (e.g., with a simple GUI) to identify a context in which the application is used. The context controller 174 stores the information in the audio context data 222 for future use and changes the playback processing appropriately.

In one embodiment, an application may be associated with more than one type of content, such as media players, and the content cannot be determined solely by looking at the application. The context controller 174 may evaluate the files the application has open (has a lock on), to determine what type of content is currently playing (e.g., by checking the file extension).

5) Making Advanced Recordings of VoIP Calls.

The context controller 174 may be configured to interact with active applications to configure audio processing through application controls. For example, the context controller 174 can communicate with both the audio signal processing system and with, for example, a VoIP application.

In one embodiment, the context controller 174 sends a request to the VoIP application to record far end and near end signals separately into files, or as separate channels in the same file. Alternatively, the context controller 174 can request the VoIP application or the audio signal processing system to stream a copy of the far end and near end signals, allowing the background application to perform such recording into files. If the streaming is handled by the audio signal processing components, it can be implemented, for example, through a virtual recording-endpoint, and it can tap the signals after compensation for relative delays between the playback and capture paths. The files can be stored on the local device or on another device, e.g. through Bluetooth.

In another embodiment, the near and far end signals are recorded into a mix of the two signals (e.g., by a weighted sum of the signals). If the streaming is done from the audio signal processing components, the mixing can be done by the DSP it rather than at the background application, so the mix is streamed out to the application.

In another embodiment, the context controller 174 sends a request to the audio signal processing components to add spatial dimension to the captured audio and/or playback (e.g. by providing the signal processing components with an angle (direction) based on who is talking). The audio signal processing components may then change the relative phase and amplitude between left and right channels to deliver a psycho-acoustic effect of changing direction. The context controller may set the angle according (for example) to: (i) which person is talking, by querying information from the VoIP application; (ii) which person is talking, by extracting biometrics to decide between persons that are talking; or (iii) through other context-based information.

In various embodiments, the context controller 174 may be used to attach metadata to the recording files, e.g. start-time and duration of the call, names of all participants, the name of the person speaking at each section, perform further offline batch processing of the recording to prepare it for speech recognition, e.g. non real-time algorithms for removal of undesired sounds (e.g. heavy, or non-causal, or involving a large delay), or algorithms for segmentation of the signal, or algorithms that are degrade the quality for human listening but improve quality for speech recognition engine, or send the recording to a speech recognition engine to get dictation results.

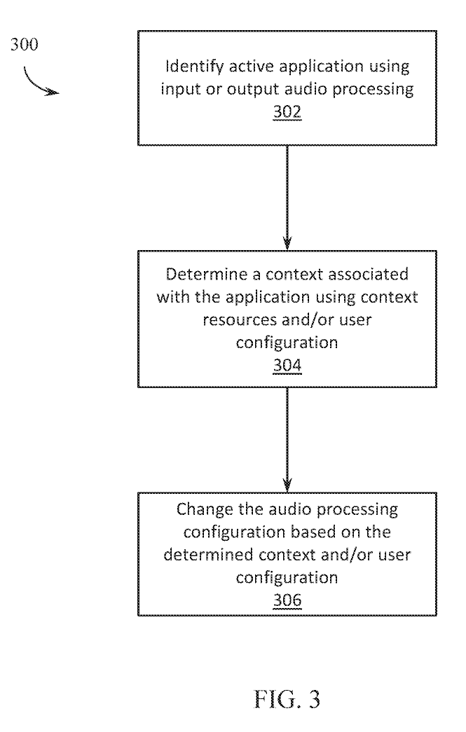

FIG. 3 is an embodiment of a flow chart of a method for context aware control and configuration of audio processing performed by a device. A method 300 for context aware control and configuration of audio processing includes identifying an active application using input or output processing (step 302), determining a context associated with the application using context resources and/or user configuration (step 304), and changing the audio processing configuration based on the determined context and/or user configuration (step 306). In various embodiments, the step of identifying 302 may include running a background application to monitor activities processed by the device and collecting application and audio resource information, including information on active applications using the audio processing resources.

The step of determining (step 304) may include, in various embodiments, using a decision map to determine if automated action should be performed, including updating a configuration of the audio processing system. In step of changing (step 306), the audio processing system may be updated, in various embodiments, by automatically switching input and output processing to conference mode, deciding when to display user controls, providing conference virtualization, automatically or manually changing playback processing based on a user configuration for each application.

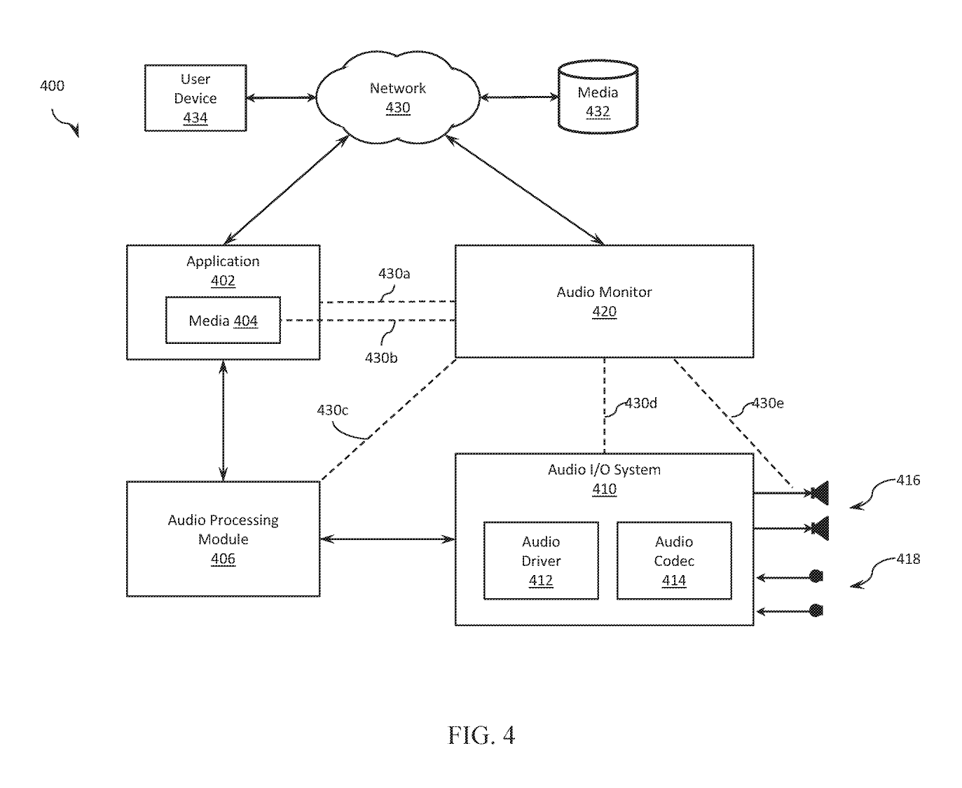

An exemplary embodiment of automatic output mode switching will now be described with reference to the system 400 illustrated in FIG. 4. The system 400 includes an application 402 that utilizes audio media 404 for output to an endpoint device, such as loudspeakers 416. The application 402 may include a web application, a video player, a VoIP communications application, or other application that generates or receives audio media. The audio media 404 may include real time audio data received from one or more input endpoint devices, such as device microphones 418, received from another device 434 across a network such as a mobile telephone during a wireless telephone call. The audio media 404 may also include media files retrieved from local storage, network storage 432 such as cloud storage, a website or Internet server, or other locations.

The system 400 includes an audio input/output system 410 comprising a combination of hardware and software for receiving audio signals from the one or more microphones 418 and driving the playback of audio signals through the one or more loudspeakers 416. As illustrated the audio I/O system 410 includes a hardware codec for interfacing between the system 400 hardware and audio input/output devices, including digitizing analog input signals and converting digital audio signals to analog output signals. The audio I/O system 410 further includes audio driver software 412 providing the system 400 with an interface to control the audio hardware devices. An audio processing object (APO) 406 provides digital audio input and output processing of audio signal streams between the application 402 and the audio I/O system 410. An APO may provide audio effect such as graphics equalization, acoustic echo cancellation, noise reduction, and automatic gain control.

In operation, the system 400 may run a plurality of applications 402 that interface with one or more APOs 406 to provide audio processing for one or more audio input or output devices 418/416. For example, the system 400 may comprise a laptop computer running multiple applications 402 such as web browsers, media applications and communications applications, such as VoIP communications. The audio I/O system 410 may also comprise various input or output devices 418/416, for example a laptop speaker may be used for audio playback, a user may have external loudspeakers or use headphones. In an exemplary operation, a user may seamlessly switch between applications, media sources (including sources having different media types) and audio I/O devices during operation.

An active audio session may include one or more audio streams communicating between applications 402 and audio endpoint devices 418/416, with audio effects provided by the audio processing module 406. In a conventional operation, the audio processing module 406 operates in a default mode or user configured mode that is used by all applications and media. For example, a user may select a music playback mode that is then used by all applications and media, including movies and VoIP calls.

In accordance with the illustrated embodiment, an audio monitor 420 is provided on the system to monitor and configure the audio processing in real time. In one embodiment, the audio monitor 420 runs in the background and does not require interaction or attention from a user of the system, but may include a user interface allowing for configuration of user control and preferences. As illustrated, the audio monitor 420 may track active applications and audio sessions 430a, media types 430b, capabilities of current audio processing module 430c, user configuration and system configurations of audio hardware and software 430d and audio endpoint devices 430e. The audio monitor 420 tracks audio system configuration and usage and adjusts audio settings to optimize the playback settings.

In one embodiment, the audio monitor 420 determines the media type and configures the audio processing module 406 to an available audio mode matching the determined media type. For example, configurations for audio playback type may include movie, music, game and voice playback modes. One or more applications may actively provide audio streams to an end point device. The audio monitor 420 identifies the media 404 playing in an active audio session and analyzes the media type. In one embodiment, the media 404 is retrieved from a network 430 and played via the application 402 (e.g., a video played on a website or audio media played through a mobile phone app). The audio monitor 420 identifies the media source and retrieves information about the online media 432 to determine media type information. For example, the audio monitor 420 may access an online video and download associated metadata and website information, which may include a media category and filetype. The audio monitor 420 may also request information, as available, from an associated online app or webpage. In another embodiment, the media 404 may be a local file and retrieved locally by the audio monitor 420.

The audio processing module 406 includes various playback effects that may be configured by the user or implemented through known media types. In one embodiment, the audio processing module is a Windows APO. The audio monitor 420 identifies media playback options available in the active audio processing module and automatically configures the audio processing module 406 for optimal playback.

In another exemplary embodiment, the application 402 is a VoIP call (e.g, a Skype call) providing both input and output audio processing. The audio input stream may be received from microphones 418 and an output stream may be received another user device 434 across the network 430 for playback on loudspeakers 416. The audio monitor 420 can configure the audio processing module for acoustic echo cancellation, noise reduction, blind source separation of target source, playback mode, and other digital audio processing effects depending on the detected configuration. For example, the system 400 may be playing music out the loudspeaker resulting in an echo received through the microphones 418.

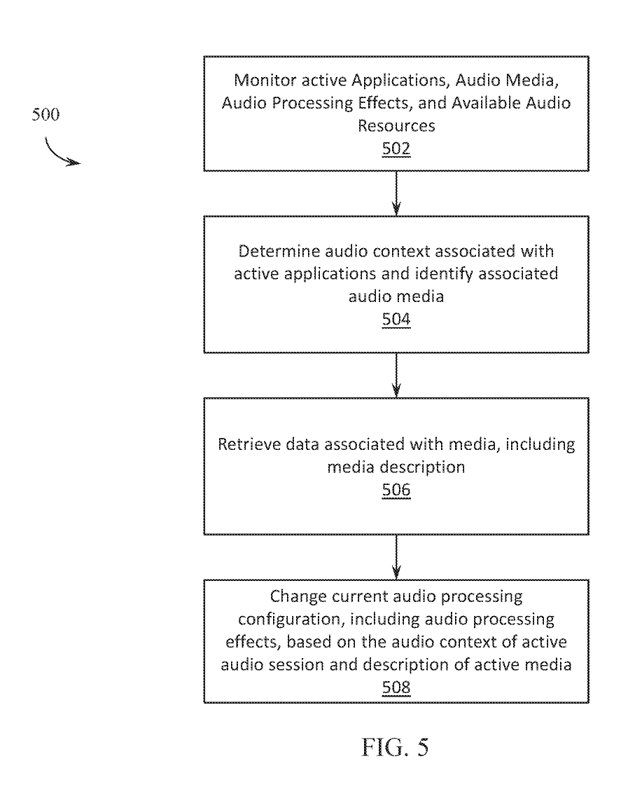

Referring to FIG. 5, an exemplary computer implemented process 500 for configuring audio playback settings will now be described. In step 502, an audio monitor application monitors active applications, audio media, audio processing effects and available audio resources. In one embodiment, the audio monitor application regularly polls the system (e.g., every 5 seconds) for active audio sessions. In step 504, the audio monitor application determines a current audio context associated with active application and audio sessions, including identifying associated audio media. In one embodiment, the audio monitor maintains information on active sessions such as associated applications and media information (e.g., media file name, HTTP link). In step 506, the audio monitor retrieves data associated with the identified media, including a media description which may be obtained through file metadata, the associated application, location of file, web domain, link and related information from web page. For example, a local media file may include an extension indicating a file type (e.g., .mp4, .avi, .mov) and file metadata indicating media type (speech, movie, game) and genre information. In step 508, the audio monitor modifies a current audio processing configuration, including audio processing effects, based on the audio context of active audio session and description of active media. In one embodiment, the audio monitor determines available audio output processing and audio output modes available through the active audio processing module and configures the audio processing module to optimize the output processing, for example, by selecting a movie, music, voice or game output mode.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for configuring audio processing, the method comprising:
monitoring audio activity on device, the device having at least one microphone and a digital audio processing unit;
collecting information from the monitoring of the activity, including an identification of at least one application utilizing audio processing;
determining a context for the audio processing, the context including at least one context resource;
determining an audio configuration based on the application and determined context; and
performing an action based on the determined audio configuration.

2. The method of claim 1, wherein the context resource includes audio media having associated metadata, and wherein the performed action based on the determined audio configuration includes configuring an output audio processing mode.

3. The method of claim 1, further comprising:
automatically switching input and output processing to conference mode, based on the determined context.

4. The method of claim 1, further comprising:
displaying user controls associated with a current application and determined context, the user controls providing additional audio processing mode control.

5. The method of claim 1, further comprising:
providing conference virtualization.

6. The method of claim 1, further comprising:
changing playback processing based on user choices for each application stored in a database.

7. The method of claim 1, further comprising:
interacting with active applications to configure audio processing through application controls.

8. The method of claim 7, further comprising:
sending a request to a VoIP application to record far end and near end signals.

9. The method of claim 8, wherein the VoIP application is instructed to stream a copy of the far end and near end signals, allowing a background application to record the far end and near end signals into files.

10. The method of claim 9 wherein the streaming is handled through audio processing components through a virtual recording-endpoint.

11. An audio processing system, comprising:
a non-transitory memory storing machine-readable instructions for audio processing; and
one or more hardware processors coupled to the non-transitory memory and configured to read instructions from the non-transitory memory to cause the system to perform operations comprising:
monitoring audio activity on device, the device having at least one microphone and a digital audio processing unit;
collecting information from the monitoring of the activity, including an identification of at least one application utilizing audio processing;
determining a context for the audio processing, the context including at least one context resource;
determining an audio configuration based on the application and determined context; and
performing an action based on the determined audio configuration.

12. The audio processing system of claim 11, wherein the context resource includes audio media having associated metadata, and wherein the performed action based on the determined audio configuration includes configuring an output audio processing mode.

13. The audio processing system of claim 11, wherein the performed operations further comprise automatically switching input and output processing to conference mode, based on the determined context.

14. The audio processing system of claim 11, wherein the performed operations further comprise displaying user controls associated with a current application and determined context, the user controls providing additional audio processing mode control.

15. The audio processing system of claim 11, wherein the performed operations further comprise changing playback processing based on user choices for each application stored in a database.

16. The audio processing system of claim 11, wherein the performed operations further comprise interacting with active applications to configure audio processing through application controls.

17. The audio processing system of claim 16, wherein the performed operations further comprise sending a request to a VoIP application to record far end and near end signals.

18. The audio processing system of claim 17, wherein the VoIP application is instructed to stream a copy of the far end and near end signals, allowing a background application to record the far end and near end signals into files.

19. The audio processing systems of claim 18 wherein the streaming is handled through audio processing components through a virtual recording-endpoint.

20. A non-transitory machine-readable medium having stored thereon machine-readable instructions executable to cause a machine to perform operations comprising:
monitoring audio activity on device, the device having at least one microphone and a digital audio processing unit;
collecting information from the monitoring of the activity, including an identification of at least one application utilizing audio processing;
determining a context for the audio processing, the context including at least one context resource;
determining an audio configuration based on the application and determined context; and
performing an action based on the determined audio configuration.
